(19) United States
(12) Patent Application Publication
(10) Pub. No.: US 2025/0070594 A1
(43) Pub. Date: Feb. 27, 2025

(54) DISASTER PREVENTION, EARLY WARNING AND PRODUCTION DECISION SUPPORT METHOD AND SYSTEM FOR POWER DISTRIBUTION NETWORK

(71) Applicant: Electric Power Science Research Institute of Guangxi Power Grid Co., Ltd., Nanning (CN)

(72) Inventors: Wei ZHANG, Nanning (CN); Shan LI, Nanning (CN); Yangsheng LIU, Nanning (CN); Weixiang HUANG, Nanning (CN); Zongtao QIN, Nanning (CN); Bo FENG, Nanning (CN); Jianna OUYANG, Nanning (CN); Rongrong WU, Nanning (CN)

(21) Appl. No.: 18/944,581

(22) Filed: Nov. 12, 2024

Related U.S. Application Data
(63) Continuation of application No. PCT/CN2023/121445, filed on Sep. 26, 2023.

(30) Foreign Application Priority Data
Jul. 6, 2023 (CN) 2023108207803

(51) Int. Cl. H02J 13/00; G05B 13/04

(52) U.S. Cl. CPC H02J 13/00002; G05B 13/048

(57) ABSTRACT

The present invention discloses a disaster prevention, early warning and production decision support method and system for a power distribution network, and relates to the technical field of the power distribution network. Various data is fused, a maximum wind load, a lightning trip-out rate, a maximum carrying capacity at a highest operation temperature and an average failure frequency and time under an environmental factor are calculated, and a power outage risk is evaluated and classified; and after an emergency, a power grid topology is analyzed, and a device outage probability is calculated to obtain a load power outage probability and risk and provide disaster early warning, monitoring and rush repair decision support.

### CROSS-REFERENCE TO RELATED APPLICATIONS

The present application claims priority to Chinese Patent Application No. 2023108207803, filed on Jul. 6, 2023, the entire disclosure of which is incorporated herein by reference.

### TECHNICAL FIELD

The present invention relates to the technical field of a power distribution network, and in particular to a disaster prevention, early warning and production decision support method and system for a power distribution network.

### BACKGROUND

Due to the frequent occurrence of natural disasters, particularly extreme weather such as typhoon, lightning, hail, rain and snow and severe convection weather, great harm to the safe and stable operation of a power distribution network will be caused, and it is likely to cause large-scale power outages. The power distribution network is at the end of a power system and undertakes the task of directly supplying power to users. When a disaster occurs, if the power distribution network is affected by the disaster to cause power outage, a great loss will be led to the users. Although the research on improving the disaster resistance to the power grid at home and abroad has been constantly enriched, the current research on the disaster prevention of the power grid mainly focuses on electric transmission lines, and there is less research on the disaster prevention of the power distribution network, even less research on intelligent disaster early warning of the power distribution network. In fact, compared with power transmission devices, due to the large number of power transmission devices and the complex power distribution network, the influence process is more complicated and changeable when being affected by natural disasters such as typhoon, and mountain fire, lightning, waterlogging, geology and icing, multiple faults are prone to occur so as to cause difficulty in prediction and processing. In aspect of meteorological environment monitoring, existing technologies about disaster early warning and processing are mostly to mount actual meteorological environment monitoring apparatuses in the power grid and then receive and acquire data transmitted by the apparatuses for further processing. The disadvantage of this method is that not all areas are equipped with the actual meteorological environment monitoring apparatuses so as to lead to the inability to obtain meteorological environment data in some areas, thereby affecting the accuracy of the final output result.

In view of this, a disaster prevention, early warning and production decision support method and system for a power distribution network are required.

### SUMMARY

In the prior art, the current research on the disaster prevention of the power grid mainly focuses on electric transmission lines, and there is less research on the disaster prevention of the power distribution network, even less research on intelligent disaster early warning of the power distribution network. Compared with power transmission devices, due to the large number of power transmission devices and the complex power distribution network, the influence process is more complicated and changeable when being affected by natural disasters such as typhoon, mountain fire, lightning, waterlogging, geology and icing, and multiple faults are prone to occur. In aspect of meteorological environment monitoring, existing technologies about disaster early warning and processing are mostly to mount actual meteorological environment monitoring apparatuses in the power grid and then receive and acquire data transmitted by the apparatuses for further treatment. The disadvantage of this method is that not all areas are equipped with the actual meteorological environment monitoring apparatuses so as to lead to the inability to obtain meteorological environment data in some areas, thereby affecting the accuracy of the final output result. The present invention provides a disaster prevention, early warning and production decision support method and system for a power distribution network, so that the power outage risk of the power distribution network can be determined based on the acquired multiple data and then the load power outage probability and power outage risk can be further obtained after disasters and other emergencies. The specific technical solutions are as follows:
a disaster prevention, early warning and production decision support method for a power distribution network includes the following steps:
S1: collecting potential emergency information, wherein the emergency comprises typhoon, lightning, high temperature and severe environmental information;
S2: evaluating a power outage risk of the power distribution network based on the emergency information so as to obtain the coping capacity of the power distribution network on the emergency, and performing disaster loss classification;
S3: determining whether to enter early warning based on the power outage risk of the power distribution network, continuously collecting the potential emergency information and evaluating the power outage risk of the power distribution network if there is no need to enter the early warning, and implementing an early warning measure if entering the early warning;
S4: after the emergency, stopping the device, and starting a stand-by power supply path (or device) that is startable after the device is stopped and designed in an emergency management plan so as to update a topological structure of the power grid;
S5: analyzing the updated topological structure of the power grid, if an isolated land power grid operates away from a main grid, calculating a difference between power generation and load for the isolated land power grid so as to obtain a power outage load, and if the power grid remains intact, solving a minimum loss cutting load, that is, a load required to be cut to maintain the power supply of a system key load under the condition of meeting the operation requirement of the power grid and the capacity constraint of the device; and
S6: calculating a device outage probability, and calculating a load power outage probability and a power outage risk based on a power outage load and the device outage probability.

Preferably, the evaluating a power outage risk of the power distribution network is specifically as follows: calculating a maximum wind load, a lightning trip-out rate, a maximum carrying capacity at a highest allowable operation temperature, and an average failure frequency and average failure time under a considered environmental factor.

Preferably, the calculating a maximum wind load is specifically as follows:

a calculation formula of a line wind load is as follows:

$${W}_{x} = 6.25 \times {10}^{- 4} {αμ}_{z} {μ}_{sc} {β}_{c} {dl}_{H} {v}^{2} {sin}^{2} θ$$

in the formula, Wₓ is a standard value of a wind load of a lead, N; α is an uneven coefficient of a wind pressure of the lead; μₛₓ is a wire shape coefficient, it is stipulated in GB 50545 that 1.2 is taken when d<17 mm and 1.1 is taken when d>=17 mm; β_{c} is a wind load adjusting coefficient, a voltage grade is 500 kV/750 kV, and others are directly taken as the outer diameter of the lead, mm; l_{H} is a horizontal span of a pole and tower, m; μ_{z} is a wind pressure height change coefficient; θ is an included angle between a wind direction and the lead;
performing probability distribution fitting by a generalized extreme value distribution, wherein the generalized extreme value distribution is divided into a I type extreme value distribution, a II type extreme value distribution and a III type extreme value distribution, and a generalized extreme value distribution function expression obtained by generalizing three different types of extreme value distributions is:

$$F ( x ; a , b , r ) = exp \{ - [ 1 + {r ( \frac{x - b}{a} )}^{- 1 / r} ] \}$$

in the formula: r is a shape parameter, a is a scale parameter, and b is a position parameter;
a variation coefficient of a feeder design wind load is:

$$Z = \frac{σ}{μ}$$

in the formula: μ is an average value of the feeder design wind load, and σ is a standard deviation of a line design wind load;

calculating a fault probability of an overhead feeder by a stress-strength interference area method, wherein the probability distribution of the feeder design wind load is a normal distribution:

$$g ( {w}_{d} , {μ}_{d} , {σ}_{d} ) = \frac{1}{{σ}_{d} \sqrt{2 π}} {e}^{\frac{- {( {w}_{d} - {μ}_{d} )}^{2}}{2 {σ}_{d}^{2}}}$$

therefore, a feeder outage probability prediction model based on a wind disaster is as follows:

$$P = 1 + {\int }_{0}^{+ ∞} exp [ - exp ( - \frac{{w}_{d} - b}{a} ) ] \frac{1}{{σ}_{d} \sqrt{2 π}} {e}^{\frac{- {( {w}_{d} - {μ}_{d} )}^{2}}{2 {σ}_{d}^{2}}} {dw}_{d}$$

a fatigue damage coefficient is:

$$ζ = \frac{{W}_{d}^{′}}{{W}_{d}} ;$$

and
the maximum wind load borne by the damaged line is:

$${W}_{d}^{′} = {ζ ( \frac{t}{α} )}^{log ( \frac{1}{{β}^{β - 1}} ) {ζ}_{2}} \cdot {W}_{d}$$

in the formula: ζ is a fatigue damage coefficient, W_{d}′ is an actually borne wind load, W_{d} is a wind load borne by the design, ζ₂ is a fatigue damage coefficient when the service life of the line reaches, β is a shape parameter, and a is a scale parameter.

Preferably, the calculating a lightning trip-out rate is as follows:
a calculation formula of the lightning trip-out rate is:

η=N_{g}Sξσ

in the formula: ·η is the lightning trip-out rate, times (100 km·a)−1; N_{g} is a ground flash density, represents the intensity of lightning activity and is only related to the characteristic of the lightning activity, times km−2·a−1; S is an effective lightning area causing line tripping and is generally within the range of 0.5 km from the unilateral distance of the line, km; and ξ is a probability of insulator flashover caused by lightning within the effective area.

Preferably, the calculating a maximum carrying capacity at a highest allowable operation temperature is specifically as follows:
acquiring a meteorological environment parameter prediction value along an overhead line by means of a WRF numerical weather forecasting system; and
calculating a dynamic current-carrying value of the line in the future by a lead heat balance equation, wherein a calculation formula of the maximum carrying capacity I of the line is as follows:

$$I = \sqrt{\begin{matrix}\{ π \text{?} ε [ {( \text{?} + 273 )}^{4} - {( \text{?} + 273 )}^{4} ] + 2.367 ( \text{?} - \text{?} ) \times \\ [ 2.42 \times {10}^{- 3} + 3.6 ( \text{?} + \text{?} ) ( \text{?} - \text{?} ) \times {10}^{- 5} ] \text{?} \\ [ \frac{\text{?} {D}_{0} {ρ}_{f}}{1.32 \times {10}^{- 5} + 4.75 ( \text{?} + \text{?} ) \times {10}^{- 8}} \text{?} - α \text{?} sin \text{?} \} / R ( \text{?} )\end{matrix}} ;$$

$$\text{?} \text{indicates text missing or illegible when filed}$$

and
in the formula, Ta is an environmental forecast temperature, Tc is a lead temperature, V_{dw} is an error of a predicted wind speed and actual data, R(Tc) is a constant value, and other parameters are meteorological environment data along the line.

Preferably, the calculating an average failure frequency and average failure time under a considered environmental factor is specifically as follows:

$${f}_{to} = {f}_{ad} {P}_{ad} + {f}_{no} ( 1 - {P}_{ad} ) ;$$

and

$${r}_{to} = {r}_{ad} {P}_{ad} + {r}_{no} ( 1 - {P}_{ad} ) ;$$

and
in the formula: f_{ad} and fₙₒ are respectively failure frequencies under hard and normal climatic conditions, fₜₒ is an average failure frequency, r_{ad} and rₙₒ are respectively average repair time under two climatic conditions, rₜₒ is average repair time during the whole period, and P_{ad} and (1−P_{ad}) are probabilities of severe and normal climatic conditions.

Preferably, the steps S4-S6 are specifically as follows:
stopping the device, starting the stand-by power supply path (or device) that is startable after the device is stopped and designed in an emergency management plan so as to update the topological structure of the power grid, analyzing the updated topological structure of the power grid, if an isolated land power grid operates away from a main grid, calculating the difference between power generation and the load for the isolated land power grid so as to obtain the power outage load, if the power grid remains intact, calculating the optimization problem of the minimum loss cutting load, solving the minimum loss cutting load required to be cut to maintain the power supply of a system key load under the condition of meeting the operation requirement of the power grid and the capacity constraint of the device, updating a non-power-outage probability of the calculated load required to be cut until traversing all affected device set, then calculating a power outage probability of each load, and finally calculating a power outage risk of an urban power distribution network in the case of the emergency;
calculating a risk R by using a product of an occurrence probability pᵢ of a disaster i and a hazard severity Cᵢ, wherein the disaster severity is expressed by a power outage load or is expressed by a value representing the importance of the load:

$$R = {\sum }_{i = 1}^{n} {p}_{i} {C}_{i} = {\sum }_{i = 1}^{n} {p}_{i} {c}_{i} {P}_{i}$$

a value coefficient c, is generally determined artificially according to the demand of ensuring power supply in emergency management, for example, the load value of municipal government, hospital and transportation systems is large, and a larger value coefficient is set for related venues and traffic facilities during major public events such as the Olympic Games; and
analyzing the updated topological structure of the power grid, if an isolated land power grid operates away from a main grid, “calculating a difference between power generation and load for the isolated land power grid” so as to obtain a power outage load, and if the power grid remains intact, solving a load required to be cut to maintain the power supply of a system key load under the condition of meeting the operation requirement of the power grid and the capacity constraint of the device by using the optimization problem of the available minimum loss cutting load,
wherein a target function of the minimum loss cutting load problem is:

$$min G ( P ) = {\sum }_{i = 1}^{n} {c}_{i} ( {P}_{i} - {P}_{i}^{*} )$$

the constraint condition is:

$$\{ \begin{matrix}f ( V , θ , {P}^{*} , {Q}^{*} ) = 0 \\ {V}_{k}^{min} \leq {V}_{k} \leq {V}_{k}^{max} k ∈ Ω \\ - {F}_{1}^{max} \leq {F}_{1} \leq {F}_{1}^{max} 1 ∈ ψ\end{matrix}$$

in the formula, Pᵢ is an initial active power of a load i, P*ᵢ is an active power of the load i after an emergent cutting load measure is taken, f is a network flow equation, V and θ are voltage and phase angle vectors of all nodes, P* and Q* are respectively active and reactive power vectors of all loads after the cutting load measure, Vₖ is a voltage amplitude of the node, Ω is a node set, Fₗ, is a transmission power of a branch l, and Ψ is a branch set.

A disaster prevention, early warning and production decision support system for a power distribution network applies the above method and includes a multivariate data access module, an external public data module, a data fusion module and a display module, where the multivariate data access module is configured to access meteorological data, typhoon data, and lightning and mountain fire data; the external public data module is configured to store public early warning data; the data fusion module is configured to process various acquired data and applying model analysis to obtain a result; and the display module is configured to interact with a client, and display various original data acquired by the multivariate data access module, result data produced in the data fusion module and data stored in the external public data module to the client.

Preferably, the meteorological data includes real-time data, forecast data and historical data of a humidity, a precipitation, a temperature, a wind direction, a wind speed and an air pressure; the typhoon data includes typhoon basic information, a typhoon grade, a forecast path, a real-time path and a forecast grade; the lightning and mountain fire data includes a thunderfall point and a fire point; and the public early warning data includes an early warning information title, a type, a grade, early warning text information, an early warning state, release time and end time.

Preferably, the disaster prevention, early warning and production decision support system for a power distribution network further includes a service domain data module, where the service domain data module includes a production domain module, a dispatching automation module, a marketing domain module, a power distribution automation module, a customer service module, a measurement automation module and a GIS module; a device ledger, a fault, a defect, a plan and power outage data are stored in the production domain module; an on-off action, a fault type and fault time are stored in the dispatching automation module; a customer ledger, a distribution transform ledger and power outage data are stored in the marketing domain module; an on-off action, a fault type and fault time are stored in the power distribution automation module; a geographic position, a distribution network topology and a risk hidden danger point are stored in the customer service module; a customer ledger, a distribution transform ledger and power outage data are stored in the measurement automation module; and the GIS module is provided with a GIS topology, a multi-functional layer waterlogging and water leaching label and a distribution network line pole and tower dotting service.

Compared with the prior art, the present invention has the beneficial effects that:
according to the present invention, various data of a data center can be fused for classification, analysis and feature extraction of multi-source data (such as meteorological data, device ledger data and operation data) of the power distribution network, so that the meteorological environment data is acquired through a WRF numerical forecast product and is further processed without mounting a meteorological environment monitoring apparatus, the power outage risk of the power distribution network is evaluated by calculating the maximum wind load, the lightning trip-out rate, the maximum carrying capacity at the highest allowable operation temperature and the average failure frequency and average failure time of the considered environmental factor, and risk classification is performed, so that the staff can upgrade the device or power distribution network with high risk level before the disasters and other emergencies occur. After the disasters and other emergencies occur, the device outage probability is further calculated by analyzing the topological structure of the power grid after the device stops, and the load power outage probability and power outage risk are calculated based on the power outage load and the device outage probability, so that the auxiliary decision making of the pre-disaster warning, disaster monitoring and post-disaster emergency repair of the power distribution network under the disasters such as typhoon, lightning, flood and icing is achieved, and data and service support is provided for the safe production, planning management, and commanding and decision-making of the power distribution network.

### BRIEF DESCRIPTION OF DRAWINGS

To more clearly illustrate the specific embodiments of the present invention or the technical solutions in the prior art, accompanying drawings needing to be used in the description of the specific embodiments or the prior art will be briefly described below. In all the accompanying drawings, similar elements or portions are generally identified by similar reference numerals of the accompanying drawings. In the accompanying drawings, each element or portion is not necessarily drawn to the actual scale.

FIG. 1 is a flow chart of determining a power outage risk of a power distribution network according to the present invention;

FIG. 2 is a flow chart of handling an emergency according to the present invention;

FIG. 3 is a schematic diagram of calculating a trip-out rate according to the present invention;

FIG. 4 is a schematic diagram of data acquisition and result classification according to the present invention; and

FIGS. 5a-5b are schematic diagrams of a disaster prevention, early warning and production decision support system for a power distribution network according to the present invention.

### DETAILED DESCRIPTION OF THE EMBODIMENTS

The technical solutions in the embodiments of the present invention are clearly and completely described below in conjunction with the drawings in the embodiments of the present invention. Apparently, the embodiments described are merely a part rather than all of the embodiments of the present invention. All other embodiments obtained by those of ordinary skilled in the art based on the embodiments of the present invention without creative efforts shall fall within the protection scope of the present invention.

It should be understood that when used in the specification and the appended claims, the terms “comprise” and “include” indicate the existence of the described features, whole, steps, s operations, elements and/or components, but do not exclude the existence or addition of one or more other features, whole, steps, operations, elements, components and/or groups thereof.

It should also be understood that the terms used in the specification of the present invention are for the purpose of describing specific embodiments only and are not intended to limit the present invention. As used in the specification of the present invention and the appended claims, the singular forms “a”, “an” and “the” are intended to include the plural forms unless the context clearly indicates otherwise.

It should also be further understood that the term “and/or” as used in the specification of the present invention and the appended claims refers to one or any combination or all possible combinations of more of items listed in association, and includes these combinations.

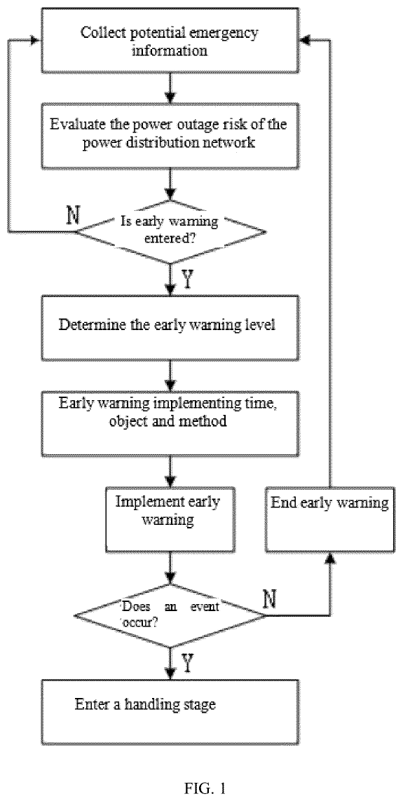

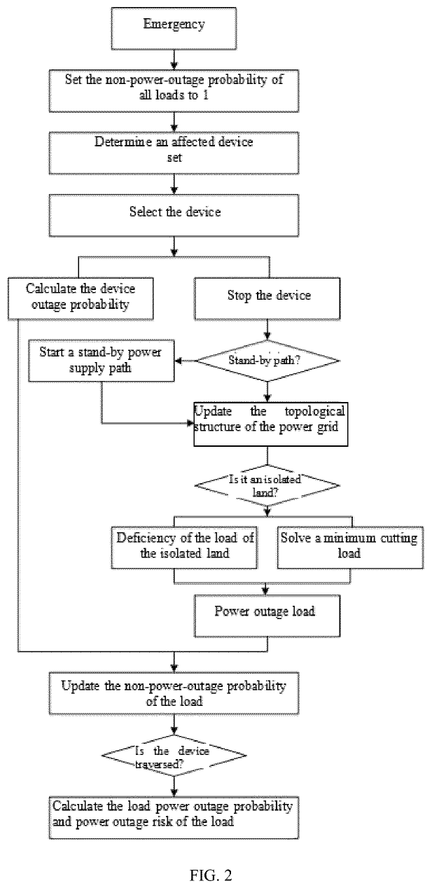

Referring to FIG. 1 and FIG. 2, this embodiment provides a disaster prevention, early warning and production decision support method for a power distribution network, including the following steps:

S1: collecting potential emergency information, wherein the emergency comprises typhoon, lightning, high temperature and severe environmental information;

S2: evaluating a power outage risk of the power distribution network based on the emergency information so as to obtain the coping capacity of the power distribution network on the emergency, and performing disaster loss classification;

S3: determining whether to enter early warning based on the power outage risk of the power distribution network, continuously collecting the potential emergency information and evaluating the power outage risk of the power distribution network if there is no need to enter the early warning, and implementing an early warning measure if entering the early warning;

S4: after the emergency, stopping the device, and starting a stand-by power supply path (or device) that is startable after the device is stopped and designed in an emergency management plan so as to update a topological structure of the power grid;

S5: analyzing the updated topological structure of the power grid, if an isolated land power grid operates away from a main grid, calculating a difference between power generation and load for the isolated land power grid so as to obtain a power outage load, and if the power grid remains intact, solving a minimum loss cutting load, that is, a load required to be cut to maintain the power supply of a system key load under the condition of meeting the operation requirement of the power grid and the capacity constraint of the device; and

S6: calculating a device outage probability, and calculating a load power outage probability and a power outage risk based on a power outage load and the device outage probability.

The principle, thought and detailed process of each step are described in detail below.

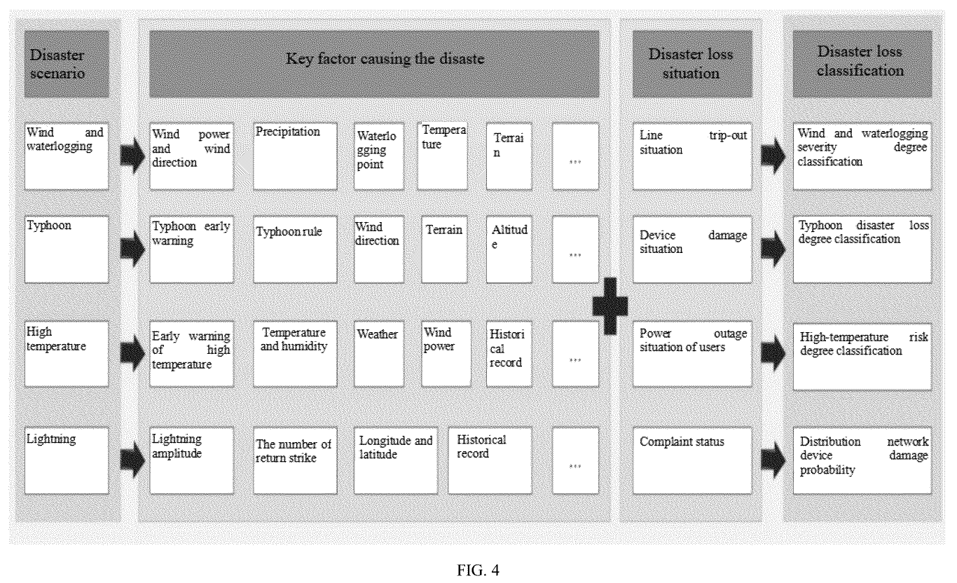

Referring to FIG. 4, to better share network data resources and avoid the problem of excessive transmission pressure of a meteorological big data network, according to the present invention, the typical disaster loss scenario and disaster loss information of the power distribution network under different natural disaster environments such as historical typhoon, lightning, flood, high temperature and ice disaster are sorted out, the disaster key factors such as geographical environment, wind speed, temperature, precipitation and time are combined with the damage situations such as the damaged device, line tripping and load loss of the power distribution network to perform correlation analysis, and the disaster loss mechanism of the power distribution network under different natural disaster environments is researched; and the disaster loss situations of different disaster environments of the power distribution network are classified in combination with national disaster prevention and early warning classification, wind and flood prevention and emergency response of power grid companies and other related regulations, corresponding power distribution network disaster loss classification libraries under different natural disaster conditions are established, and the disaster response capability of the power distribution network is evaluated.

First, the key influence factors of the disaster loss of the power distribution network such as temperature, humidity, wind speed, precipitation, typhoon level and lightning density are extracted and combined with the grid structure of the actual power distribution network, the ledger information and the device operation data to obtain the dynamic evaluation result of pre-disaster self-coping ability of the power distribution network considering the disaster loss feature of the power distribution network.

### (1) The Time-Varying Outage Model of an Overhead Feeder Under the Action of Typhoon

the calculation formula of the line wind load:

$${W}_{x} = 6.25 \times {10}^{- 14} {αμ}_{z} {μ}_{sc} {β}_{c} {dl}_{H} {v}^{2} {sin}^{2} θ \qquad ( 1 )$$

in the formula, Wx is a standard value of a wind load of a lead, N; α is an uneven coefficient of a wind pressure of the lead; Ξ_{sc} is a wire shape coefficient, it is stipulated in GB 50545 that 1.2 is taken when d<17 mm and 1.1 is taken when d>=17 mm; βc is a wind load adjusting coefficient, a voltage grade is 500 kV/750 kV, and others are directly taken as the outer diameter of the lead, mm; IH is a horizontal span of a pole and tower, m; μz is a wind pressure height change coefficient; θ is an included angle between a wind direction and the lead (°).

It can be seen from the above formula that the wind load borne by the line is closely related to the wind speed and the wind direction. Since the wind speed and the wind direction are random variables, the wind load of the line is also a random variable. Probability distribution fitting is performed by a generalized extreme value distribution, where the generalized extreme value distribution is divided into a I type extreme value distribution, a II type extreme value distribution and a III type extreme value distribution, and a generalized extreme value distribution function expression obtained by generalizing three different types of extreme value distributions is:

$$F ( x , a , b , r ) = exp \{ - [ 1 + {r ( \frac{x - b}{a} )}^{- 1 / r} ] \} \qquad ( 2 )$$

In the formula: r is a shape parameter, a is a scale parameter, and b is a position parameter.

At present, most countries (including China) adopts I type extreme value distribution for wind speed probability simulation. Therefore, the wind speed probability simulation mode is applied to prediction wind load probability distribution, that is, I type extreme value distribution is used to determine a wind load probability distribution function:

$$F ( x ; a , b , r ) = exp [ - exp ( - \frac{x - b}{a} ) ] \qquad ( 3 )$$

At present, there is a distance method, a least square method, a maximum likelihood method and a probability-weighted distance method for estimating two parameters a and b in the formula (3). The two parameters are determined by the distance method, and the calculation result is obtained from the calculation formula of root variance and mathematical expectation:

$$\{ \begin{matrix}E ( x ) = b + 0.5572 a \\ {σ}^{23} = \frac{{π}^{2} {a}^{2}}{6}\end{matrix} \qquad ( 4 )$$

$$\overline{x} = E ( x ) = \frac{1}{n} {\sum }_{i = 1}^{n} {x}_{i} \qquad ( 5 )$$

$$σ = {[ \frac{1}{n - 1} {\sum }_{i = 1}^{n} {( {x}_{i} - \overline{x} )}^{2} ]}^{1 / 2} \qquad ( 6 )$$

In the formula: x̅ is an average value of a feeder wind load.

The specific steps of the line wind load probability distribution function are as follows:
1) the wind load borne by the line is calculated according to the observed wind speed and wind direction data;
2) a maximum wind load in an interval t, the process is repeated, and several groups of maximum wind loads are selected to form an extreme value sample sequence of the wind load;
3) two parameters a and b of the wind load are estimated according to the extreme value sample sequence of the wind load in the step 2) and by the distance method; and
4) the line wind load probability distribution function under the wind disaster can be estimated according to two parameters a and b estimated each time.
   a variation coefficient of a feeder design wind load is:

$$Z = \frac{σ}{μ} \qquad ( 7 )$$

In the formula: μ is an average value of the feeder design wind load, and σ is a standard deviation of a line design wind load.

In fact, the actual wind load of the line and the designed wind load are random variables, a fault probability of an overhead feeder is calculated by a stress-strength interference area method, wherein the probability distribution of the feeder design wind load is a normal distribution:

$$g ( {w}_{d} , {μ}_{d} , {σ}_{d} ) = \frac{1}{{σ}_{d} \sqrt{2 π}} {e}^{\frac{- {( {w}_{d} - {μ}_{d} )}^{2}}{2 {σ}_{d}^{2}}} \qquad ( 8 )$$

Therefore, the present invention provides a feeder outage probability prediction model based on a wind disaster:

$$P = 1 - {\int }_{0}^{+ ∞} exp [ - exp ( - \frac{{w}_{d} - b}{a} ) ] \frac{1}{{σ}_{d} \sqrt{2 π}} {e}^{\frac{- {( {w}_{d} - {μ}_{d} )}^{2}}{2 {σ}_{d}^{2}}} {dw}_{d} \qquad ( 9 )$$

A fatigue damage coefficient is:

$$ζ = \frac{{W}_{d}^{′}}{{W}_{d}} \qquad ( 10 )$$

The maximum wind load borne by the damaged line is:

$${W}_{d}^{′} = {ζ ( \frac{t}{α} )}^{log ( \frac{1}{{β}^{β - 1}} ) {ζ}_{2}} \cdot {W}_{d} \qquad ( 11 )$$

In the formula: ζ is a fatigue damage coefficient, Wd′ is an actually borne wind load, Wd is a wind load borne by the design, ζ2 is a fatigue damage coefficient when the service life of the line reaches, β is a shape parameter, and α is a scale parameter.

### (2) A Lightning Trip-Out Probability Analysis Method and Frame

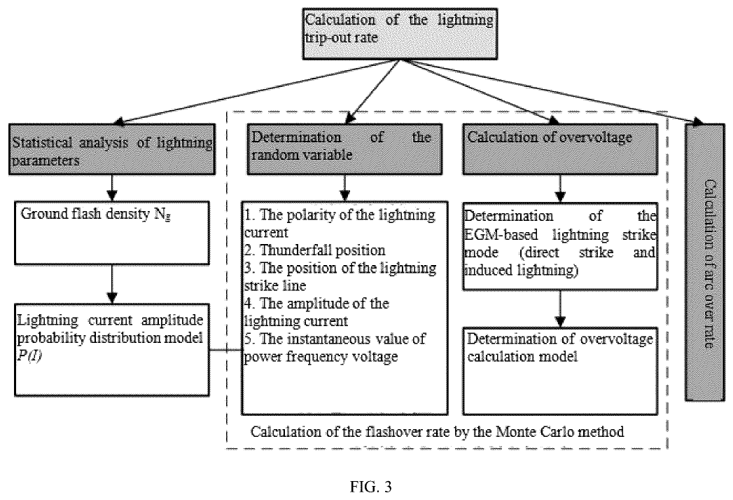

The research indicates that the trip-out of the line caused by lightning strike is required to meet: \textcircled{1} the overvoltage caused by lightning strike is greater than the lightning impulse withstand voltage value U50% of an insulator, and impact flashover occurs; and \textcircled{2} after the lightning disappears, the impact flashover is developed into a short-circuit current arc which exists persistently, thereby causing a relay protection apparatus to act and the line to trip. The lightning withstand level of the line and the grounding mode are two important factors affecting the trip-out rate of the line. Besides, the trip-out rate of the line is closely related to the frequency of local lightning activities. Therefore, referring to FIG. 3, the calculation of the lightning trip-out rate is required to consider the following three important calculation parameters: a ground flash density, a flashover rate and an arc over rate. Therefore, the calculation formula of the lightning trip-out rate is:

η=N_{g}Sξσ

in the formula: ·72 is the lightning trip-out rate, times (100 km·a)−1; Ng is a ground flash density, represents the intensity of lightning activity and is only related to the characteristic of the lightning activity, times km−2·a−1; S is an effective lightning area causing line tripping and is generally within the range of 0.5 km from the unilateral distance of the line, km; ξ is a probability of insulator flashover caused by lightning within the effective area, which is mainly related to the lightning withstand level (related to the pole and tower structure, the grounding resistance, the overhead ground wire or not, and the model of the insulator) of the line, the magnitude of the lightning current and the position of lightning strike, denoted as a flashover rate; and o is an arc over rate, which is related to the structure of the role and tower and the grounding mode.

From the above analysis, the ground flash density, the magnitude of the lightning current, the position of the lightning strike, the grounding resistance and the pole and tower structure will affect the lightning trip-out rate. From the statistical perspective, it can be divided into certainty factors (such as the grounding resistance, the span and the model of the insulator) and uncertainty factors (the amplitude of the lightning current, the frequency of ground lightning and lightning strike point). The uncertainty factors obtain the related lightning parameter statistical value and probability distribution model according to the characteristic of the lightning activity, and adopt a Monte Carlo method to calculate the flashover rate. The present invention provides an improved method for calculating the lightning trip-out rate based on the characteristic of the lightning activity on the basis of calculating the trip-out rate by the Monte Carlo method.

### (3) The Time-Varying Outage Model of the Lead in High-Temperature Weather Based on Numerical Weather Forecast

The static carrying capacity of the overhead line is a lead carrying value calculated by taking the very conservative meteorological factor as a boundary condition and based on a steady-state heat balance equation and the highest allowable operation temperature of the lead (it is stipulated in China that the steel-core aluminum stranded wire is 70° C.). The preset boundary condition cannot dynamically reflect the real-time change of the line operation state. Compared with the static carrying capacity, the dynamic carrying capacity is calculated on line based on a real-time meteorological environment parameter and by a lead heat balance equation, which can reflect the operation state of the line in real time.

At present, lead temperature-measuring and micro-meteorological parameter monitoring apparatuses are not widely mounted in a corridor of an overhead line, so the dynamic carrying capacity is not widely applied to the overhead line. As power grid dispatching and substation operation and maintenance departments, if relevant technical means can be used to predict the dynamic carrying capacity of the overhead line in advance during the summer peak electricity consumption, the decision-making basis is provided for the optimization of dispatching plan formulation and operation mode, thereby fully utilizing the dynamic carrying capacity of the line on the basis of ensuring the safe operation of the overhead line.

Numerical weather forecast is a method based on the current atmospheric state, using the mathematical model of the atmosphere to set an appropriate initial value and a boundary environment condition, using a large computer to calculate the numerical value of massive meteorological information data, and predicting the atmospheric motion state and meteorology in a certain period of time by solving a physical equation group describing the weather evolution process. At present, the widely used numerical weather forecast calculation modes mainly include the following categories: 1) WRF, a meteorological research and prediction model, which is supported by the American Meteorological Research Center, the National Oceanic and Atmospheric Administration and the Air Force Meteorological Bureau; 2) RAMS, a regional atmospheric model system, which is researched and developed by Colorado State University; 3) GEM-LAM, a global environment multi-scale finite region model, which is a Canadian meteorological service system; 4) HIRLAM, a high-resolution finite region mode, which his supported by Cooperative Institute of European Meteorology; and 5) ALADIN, which is supported by the joint organization of several European and North African countries led by French Meteorological Center. The WRF calculation mode considers the influence factors in the micro-meteorological physical process comprehensively, the forecast invention includes wind speed, temperature, solar radiation, humidity, precipitation and other elements, and the relative error limit of the relevant forecast value is 8%.

Therefore, the meteorological environment data along the overhead line in the next 24 h is obtained by using the WRF numerical forecast product, and the carrying capacity of the overhead line in the future is researched. The proposed method uses the meteorological forecast parameter of the numerical weather forecast to predict and calculate the dynamic carrying value. Reference basis can be provided for emergency personnel to complete risk evaluation in continuous high-temperature weather without mounting an actual meteorological environment monitoring apparatus.

To predict the dynamic carrying capacity of the lead in the future, it is necessary to obtain a meteorological environment parameter prediction value along the overhead line by means of the WRF numerical weather forecasting system and calculate the dynamic carrying value of the line in the future by the lead heat balance equation.

The calculation basis of the dynamic carrying capacity of the lead is:

$$I = \sqrt{\begin{matrix}\{ π {D}_{0} {σ}_{B} ε [ {( {T}_{c} + 273 )}^{4} - {( {T}_{a} + 273 )}^{4} ] + 2.367 ( {T}_{c} - {T}_{a} ) \times \\ [ 2.42 \times {10}^{- 2} + 3.6 ( {T}_{c} + {T}_{a} ) ( {T}_{c} - {T}_{a} ) \times {10}^{- 5} ] \times \\ {[ \frac{{V}_{δ} {D}_{0} {ρ}_{f}}{1.32 \times {10}^{- 5} + 4.75 ( {T}_{c} + {T}_{a} ) \times {10}^{- 3}} ]}^{0.6} - α {D}_{0} {Q}_{s} sin {θ}_{s} \} / R ( {T}_{c} )\end{matrix}}$$

when the lead temperature Tc is the highest allowable operation temperature 70° C. of the line, R(Tc) is a constant value, the meteorological environment data along the overhead line in the next 24h is substituted into a formula (3.1), and the calculation value of the maximum carrying capacity I of the line in the next 24 h at the highest allowable operation temperature can be calculated.

The error between the environment forecast temperature Ta and forecast wind speed and the actual data is calculated, the environment forecast temperature and forecast wind speed along the overhead line in the next 24 h are respectively Tₐ∈[T_{a min}, T_{a max}] and vₐ∈[v_{a min}, v_{a max}], then the predicted dynamic quantity of the line has a maximum value Imax and minimum Imin. There is an error in the ideal value provided by a numerical forecast technology, thereby calculate the prediction of the line in the next 24 h.

There is a big error in the dynamic carrying capacity, so it is necessary to consider the fluctuation of the numerical forecast technology, thereby improving the accuracy of predicting the dynamic carrying capacity. With the development of the numerical forecast technology, the meteorological environment numerical forecast interval has been more accurate in the next 24 h, so it can be considered that the actual meteorological environment data is randomly distributed in the numerical forecast interval, and the actual dynamic carrying capacity of the overhead line is also randomly distributed in the predicted dynamic carrying capacity interval. It is considered that the overhead line obeys a certain probability distribution in case of the numerical weather forecast, so that the probability outage model caused by the high-temperature weather can be obtained.

### (4) Device Outage Model Under Various Weather Conditions

Many system components may be exposed to severe and even catastrophic environments. Although this situation does not occur frequently and lasts for a short time, in this period, the fault probability of the component is significantly increased, and overlapping failure of a plurality of components of the failure of the whole subsystem may occur. It should be noted that the failure process of overlapping outage is different from the concept of common cause outage in the severe or catastrophic environment. In essence, environment-dependent outage means that only system components are dependent on the environment, not the correlation between the components. The overlapping failure of the components is still independent, but is more serious due to the influence of the common environment.

Severe environment usually refers to unfavorable weather conditions such as wind, rain and snow, and the catastrophic environment refers to natural disasters such as snowstorm, tornado, fire, flood and earthquake. Since the occurrence probability of the catastrophic environment and the influence range thereof can only be roughly estimated, it is difficult to put forward an accurate model. However, once a certain estimate is accepted in the analysis, the following reasonable assumptions can be made: all components will fail at the same time as common cause outage within the estimation range. Such assumption can implement the system risk evaluation including the catastrophic environment influence. Although this influence is simplified and may not be accurate enough, this method provides some quantitative information useful for decision-making.

For general climatic conditions, there are always available meteorological statistics, so a better simulation method can be designed. The traditional method is to divide the climate into two basic states: normal and severe. The probability of normal and severe climate states can be calculated according to meteorological data. If the failure frequency and repair time of the components can be distinguished under the normal and severe climatic states, the system risk under the two climatic conditions can be respectively evaluated, and the final risk index is obtained by weighting the probability of the two climatic conditions. However, most data acquisition systems do not distinguish the failure events under the normal and severe climatic conditions, but only the average failure frequency and average repair time in the past years. In this case, the following formulas (12) to (13) can be used to calculate the failure frequency and repair time under the two climatic conditions.

$${f}_{to} = {f}_{ad} {P}_{ad} + {f}_{no} ( 1 - {P}_{ad} ) \qquad ( 12 )$$

$${r}_{to} = {r}_{ad} {P}_{ad} + {r}_{no} ( 1 - {P}_{ad} ) \qquad ( 13 )$$

In the formula: f_{ad} and fno are respectively the failure frequencies under the severe and normal climatic conditions; fto is the average failure frequency; rad and rno are respectively average repair time under the two climatic conditions; rto is the average repair time within the whole period; and Pad and (1-Pad) are the probabilities under the severe and normal climatic conditions.

Research on the disaster early warning and risk evaluation technology of the power distribution network fusing multi-source data

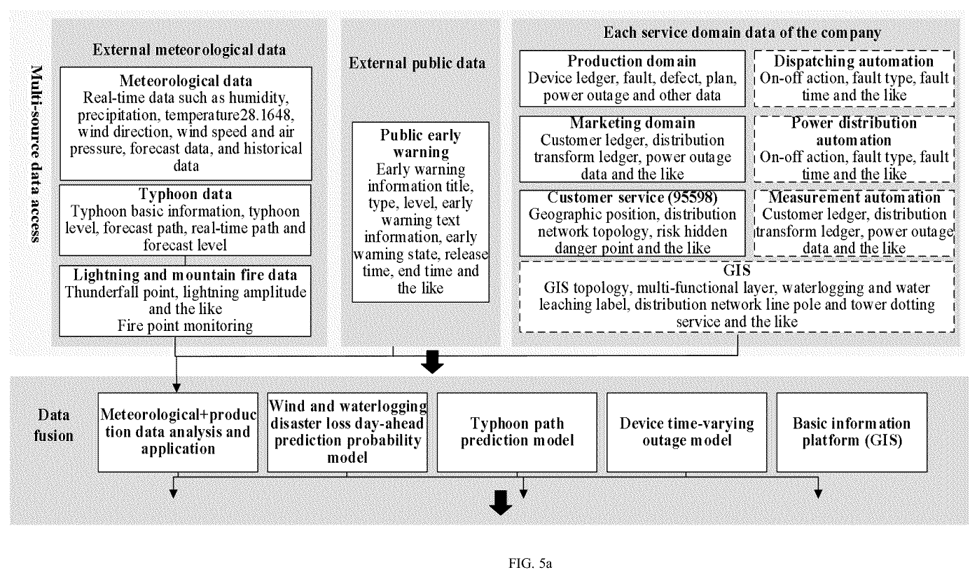

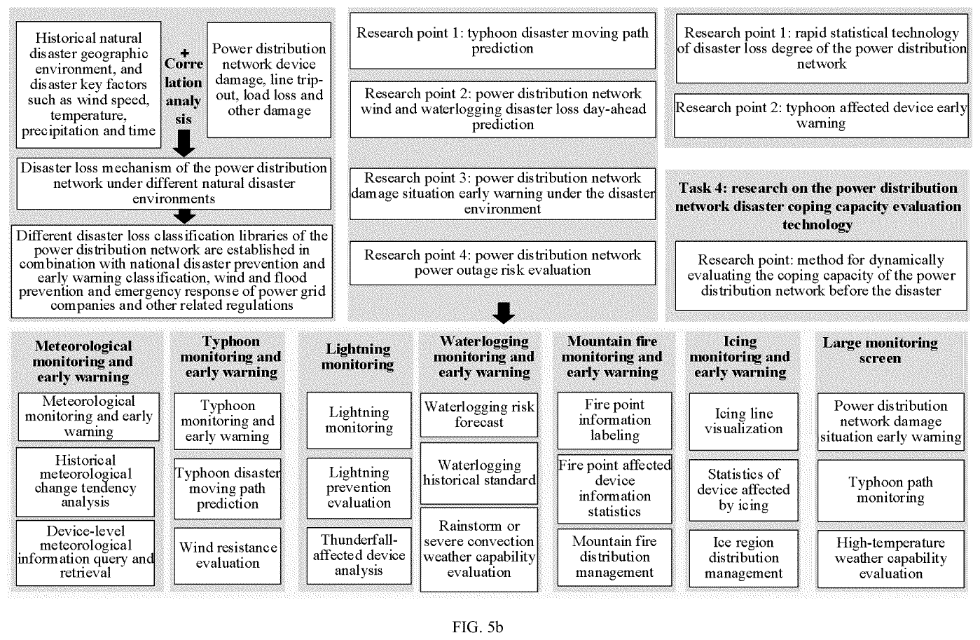

Referring to FIG. 5a and FIG. 5b, the power distribution network wind and waterlogging disaster-causing factor and day-ahead prediction method are researched, and the power distribution network wind and waterlogging disaster loss day-ahead prediction probability model is established; the meteorological environment data, the power distribution device ledger, the power distribution network operation, the GIS map and other data are fused and analyzed under different natural disaster conditions such as typhoon, lightning, high temperature, icing and severe convection weather, the power distribution network device disaster loss probability early warning mode is established, and the power distribution network disaster loss situation under the disaster environment is subjected to early warning; and the power distribution network disaster risk evaluation technology is researched, the power distribution device outage probability model is established, and the corresponding power outage load after each device is stopped is analyzed and calculated.

Referring to FIG. 2, the device is stopped, and a stand-by power supply path (or device) that is startable after the device is stopped and designed in an emergency management plan is started so as to update a topological structure of the power grid. The updated topological structure of the power grid is analyzed, if an isolated land power grid operates away from a main grid, a difference between power generation and load for the isolated land power grid is calculated so as to obtain a power outage load, and if the power grid remains intact, the optimization problem of the available minimum loss cutting load is calculated, and a load required to be cut to maintain the power supply of a system key load is maintained under the condition of meeting the operation requirement of the power grid and the capacity constraint of the device. The non-power outage probability of the obtained load to be cut is calculated until all the affected device set is traversed, and then the power outage probability of each load is calculated. Finally, a power outage risk of an urban power distribution network in the case of the emergency is calculated.

A risk R is generally calculated by using a product of an occurrence probability pᵢ of a disaster i and a hazard severity Cᵢ, where the disaster severity is expressed by a power outage load or is expressed by a value representing the importance of the load:

$$R = {\sum }_{i = 1}^{n} {p}_{i} {C}_{i} = {\sum }_{i = 1}^{n} {p}_{i} {c}_{i} {P}_{i}$$

a value coefficient cᵢ is generally determined artificially according to the demand of ensuring power supply in emergency management, for example, the load value of municipal government, hospital and transportation systems is large, and a larger value coefficient is set for related venues and traffic facilities during major public events such as the Olympic Games.

The updated topological structure of the power grid is analyzed, if an isolated land power grid operates away from a main grid, “a difference between power generation and load for the isolated land power grid is calculated” so as to obtain a power outage load, and if the power grid remains intact, a load required to be cut to maintain the power supply of a system key load under the condition of meeting the operation requirement of the power grid and the capacity constraint of the device is solved by using the optimization problem of the available minimum loss cutting load.

wherein a target function of the minimum loss cutting load problem is:

$$min G ( P ) = {\sum }_{i = 1}^{n} {c}_{i} ( {P}_{i} - {P}_{i}^{*} )$$

The constraint condition is:

$$\{ \begin{matrix}f ( V , θ , {P}^{⋆} , {Q}^{⋆} ) = 0 \\ \begin{matrix}{V}_{k}^{min} \leq {V}_{k} \leq {V}_{k}^{max} & k ϵ Ω\end{matrix} \\ \begin{matrix}- {F}_{l}^{max} \leq {F}_{l} \leq {F}_{l}^{max} & l ϵ Ψ\end{matrix}\end{matrix}$$

in the formula, Pᵢ is an initial active power of a load i, Pᵢ* is an active power of the load i after an emergent cutting load measure is taken, f is a network flow equation, V and θ are voltage and phase angle vectors of all nodes, P* and Q* are respectively active and reactive power vectors of all loads after the cutting load measure, V is a voltage amplitude of the node, Ω is a node set, F, is a transmission power of a branch I, and Ψ is a branch set.

Research on the power distribution network device operation disaster loss analysis technology

Referring to FIG. 4, FIG. 5a and FIG. 5b, the research on the rapid statistical technology of the disaster loss degree of the power distribution network, based on the existing production service power distribution network device operation data, includes power outage information, trip-out information and device defect, which fuses multi-source data such as measurement automation, GIS topology and marketing user profile, applies a big data technology, and implements the rapid statistics and analysis on the disaster loss degree of power distribution device damage, line trip-out and load loss.

The main method is: the key influence factors of the disaster loss of the power distribution network such as temperature, humidity, wind speed, precipitation, typhoon level and lightning density are extracted and combined with the grid structure of the actual power distribution network, the ledger information and the device operation data, and the rapid statistical technology for the power distribution network damage considering the disaster loss characteristic of the power distribution network is researched.

Taking the typhoon disaster loss statistics as an example, according to the analysis on relevant factors of wind field forecast, pole and tower withstand wind speed and pole and tower altitude with collapsed/broken tower and collapsed/broken pole, a pole and tower damage early warning model is researched, the list of poles and towers with the risk of collapsed/broken towers and collapsed/broken poles is warned in advance according to the typhoon prediction data before the typhoon, and the operation and maintenance staff is guided to do a good job in wind prevention and reinforcement.

In addition, this embodiment further provides a disaster prevention, early warning and production decision support system for a power distribution network, applying the above method and including a multivariate data access module, an external public data module, a data fusion module and a display module, where the multivariate data access module is configured to access meteorological data, typhoon data, and lightning and mountain fire data; the external public data module is configured to store public early warning data;

the data fusion module is configured to process various acquired data and applying model analysis to obtain a result; and the display module is configured to interact with a client, and display various original data acquired by the multivariate data access module, result data produced in the data fusion module and data stored in the external public data module to the client. The meteorological data includes real-time data, forecast data and historical data of a humidity, a precipitation, a temperature, a wind direction, a wind speed and an air pressure; the typhoon data includes typhoon basic information, a typhoon grade, a forecast path, a real-time path and a forecast grade; the lightning and mountain fire data includes a thunderfall point and a fire point; and the public early warning data includes an early warning information title, a type, a grade, early warning text information, an early warning state, release time and end time. The disaster prevention, early warning and production decision support system for a power distribution network further includes a service domain data module, where the service domain data module includes a production domain module, a dispatching automation module, a marketing domain module, a power distribution automation module, a customer service module, a measurement automation module and a GIS module; a device ledger, a fault, a defect, a plan and power outage data are stored in the production domain module; an on-off action, a fault type and fault time are stored in the dispatching automation module; a customer ledger, a distribution transform ledger and power outage data are stored in the marketing domain module; an on-off action, a fault type and fault time are stored in the power distribution automation module; a geographic position, a distribution network topology and a risk hidden danger point are stored in the customer service module; a customer ledger, a distribution transform ledger and power outage data are stored in the measurement automation module; and the GIS module is provided with a GIS topology, a multi-functional layer, waterlogging and water leaching label and a distribution network line pole and tower dotting service.

In conclusion, according to the present invention, various data of a data center can be fused for classification, analysis and feature extraction of multi-source data (such as meteorological data, device ledger data and operation data) of the power distribution network, so that the meteorological environment data is acquired through a WRF numerical forecast product and is further processed without mounting a meteorological environment monitoring apparatus, the power outage risk of the power distribution network is evaluated by calculating the maximum wind load, the lightning trip-out rate, the maximum carrying capacity at the highest allowable operation temperature and the average failure frequency and average failure time of the considered environmental factor, and risk classification is performed, so that the staff can upgrade the device or power distribution network with high risk level before the disasters and other emergencies occur. After the disasters and other emergencies occur, a device outage probability is further calculated by analyzing the topological structure of the power grid after the device stops, and a load power outage probability and a power outage risk are calculated based on a power outage load and the device outage probability. According to the present invention, the auxiliary decision making of the pre-disaster warning, disaster monitoring and post-disaster emergency repair of the power distribution network under the disasters such as typhoon, lightning, flood and icing is achieved, and data and service support is provided for the safe production, planning management, and commanding and decision-making of the power distribution network.

Those of ordinary skill in the art may realize that the module of each example described in the embodiments disclosed herein can be realized in electronic hardware, computer software or a combination of the two. In order to clearly describe the interchangeability of hardware and software, the composition of each example have been generally described in the above description according to functions. Whether these functions are performed in hardware or software depends on the specific application and design constraints of the technical solution. Those skilled in the art may use a different method for each specific application to implement the described functions, but such implementation should not be considered beyond the scope of the present invention.

In the embodiments provided by the present invention, it should be understood that division into the units is only logical function division. There may be other division manners in actual implementation, for example, a plurality of units can be combined into a unit, one unit can be divided into a plurality of units, or some features may be ignored.

In addition, functional units in the embodiments of the present invention may be integrated into one processing unit, or each of the units may be physically separated, or two or more units may be integrated into one unit. The integrated units may be implemented in a form of hardware, and may also be implemented in a form of a software function unit.

The integrated unit, if implemented in the form of a software functional unit and sold or used as a stand-alone product, may be stored in a computer readable storage medium. Based on this understanding, the technical solution of the present invention essentially or a part that contributes to the prior art; or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present invention. The storage media includes: a USB flash disk, a read-only memory (ROM), a random access memory (RAM), a mobile hard disk, a magnetic disk, an optical disk or other media that can store program codes.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof; and these modifications or replacements do not make the essence of the corresponding technical solution depart from the scope of the technical solutions of the embodiments of the present invention, and shall fall within the scope of claims and specification of the present invention.

What is claimed is:

1. A disaster prevention, early warning and production decision support method for a power distribution network, comprising the following steps:
S1: collecting potential emergency information, wherein the emergency comprises typhoon, lightning, high temperature and severe environmental information;
S2: evaluating a power outage risk of the power distribution network based on the emergency information so as to obtain the coping capacity of the power distribution network on the emergency, and performing disaster loss classification;
S3: determining whether to enter early warning based on the power outage risk of the power distribution network, continuously collecting the potential emergency information and evaluating the power outage risk of the power distribution network if there is no need to enter the early warning, and implementing an early warning measure if entering the early warning;
S4: after the emergency, stopping the device, and starting a stand-by power supply path (or device) that is startable after the device is stopped and designed in an emergency management plan so as to update a topological structure of the power grid;
S5: analyzing the updated topological structure of the power grid, if an isolated land power grid operates away from a main grid, calculating a difference between power generation and load for the isolated land power grid so as to obtain a power outage load, and if the power grid remains intact, solving a minimum loss cutting load, that is, a load required to be cut to maintain the power supply of a system key load under the condition of meeting the operation requirement of the power grid and the capacity constraint of the device; and
S6: calculating a device outage probability, and calculating a load power outage probability and a power outage risk based on a power outage load and the device outage probability.

2. The disaster prevention, early warning and production decision support method for a power distribution network according to claim 1, wherein the evaluating a power outage risk of the power distribution network is specifically as follows: calculating a maximum wind load, a lightning trip-out rate, a maximum carrying capacity at a highest allowable operation temperature, and an average failure frequency and average failure time under a considered environmental factor.

3. The disaster prevention, early warning and production decision support method for a power distribution network according to claim 2, wherein the calculating a maximum wind load is specifically as follows:
a calculation formula of a line wind load is as follows:
$${W}_{x} = 6.25 \times {10}^{- 4} {αμ}_{z} {μ}_{sc} {β}_{c} {dl}_{H} {v}^{2} {sin}^{2} θ$$
in the formula, Wₓ is a standard value of a wind load of a lead, N; α is an uneven coefficient of a wind pressure of the lead; μ_{sc} is a wire shape coefficient, it is stipulated in GB 50545 that 1.2 is taken when d<17 mm and 1.1 is taken when d>=17 mm; β_{c} is a wind load adjusting coefficient, a voltage grade is 500 kV/750 kV, and others are directly taken as the outer diameter of the lead, mm; l_{H} is a horizontal span of a pole and tower, m; μ_{z} is a wind pressure height change coefficient; θ is an included angle between a wind direction and the lead;
performing probability distribution fitting by a generalized extreme value distribution, wherein the generalized extreme value distribution is divided into a I type extreme value distribution, a II type extreme value distribution and a III type extreme value distribution, and a generalized extreme value distribution function expression obtained by generalizing three different types of extreme value distributions is:
$$F ( x ; a , b , r ) = exp \{ - [ 1 + {r ( \frac{x - b}{a} )}^{- 1 / r} ] \}$$
in the formula: r is a shape parameter, a is a scale parameter, and b is a position parameter;
a variation coefficient of a feeder design wind load is:
$$Z = \frac{σ}{μ}$$
in the formula: μ is an average value of the feeder design wind load, and σ is a standard deviation of a line design wind load;
calculating a fault probability of an overhead feeder by a stress-strength interference area method, wherein the probability distribution of the feeder design wind load is a normal distribution:
$$g ( {w}_{d} , {μ}_{d} , {σ}_{d} ) = \frac{1}{{σ}_{d} \sqrt{2 π}} {e}^{\frac{- {( {w}_{d} - {μ}_{d} )}^{2}}{2 {σ}_{d}^{3}}}$$
therefore, a feeder outage probability prediction model based on a wind disaster is as follows:
$$P = 1 - {\int }_{0}^{+ ∞} exp [ - exp ( - \frac{{w}_{d} - b}{a} ) ] \frac{1}{{σ}_{d} \sqrt{2 π}} {e}^{\frac{- {( {w}_{d} - {μ}_{d} )}^{2}}{2 {σ}_{d}^{3}}} {dw}_{d}$$
a fatigue damage coefficient is:
$$ζ = \frac{{{W}^{′}}_{d}}{{W}_{d}} ;$$
and
the maximum wind load borne by the damaged line is:
$${{W}^{′}}_{d} = {ζ ( \frac{t}{α} )}^{log ( \frac{1}{{β}^{β - 1}} ) {ζ}_{2}} \cdot {W}_{d}$$
in the formula: ζ is a fatigue damage coefficient, W_{d}′ is an actually borne wind load, W_{d} is a wind load borne by the design, ζ₂ is a fatigue damage coefficient when the service life of the line reaches, β is a shape parameter, and a is a scale parameter.

4. The disaster prevention, early warning and production decision support method for a power distribution network according to claim 2, wherein the calculating a lightning trip-out rate is specifically as follows:
a calculation formula of the lightning trip-out rate is:
η=N_{g}Sξσ
in the formula: □η is the lightning trip-out rate, times (100 km a)−1; N_{g} is a ground flash density, represents the intensity of lightning activity and is only related to the characteristic of the lightning activity, times km−2·a−1; S is an effective lightning area causing line tripping and is generally within the range of 0.5 km from the unilateral distance of the line, km; and ξ is a probability of insulator flashover caused by lightning within the effective area.

5. The disaster prevention, early warning and production decision support method for a power distribution network according to claim 2, wherein the calculating a maximum carrying capacity at a highest allowable operation temperature is specifically as follows:
acquiring a meteorological environment parameter prediction value along an overhead line by means of a WRF numerical weather forecasting system; and
calculating a dynamic current-carrying value of the line in the future by a lead heat balance equation, wherein a calculation formula of the maximum carrying capacity I of the line is as follows:
$$I = \sqrt{\begin{matrix}\begin{matrix}\{ π {D}_{0} {σ}_{B} ε [ {( {T}_{c} + 273 )}^{4} - {( {T}_{c} + 273 )}^{4} ] + 2.367 ( {T}_{c} + {T}_{a} ) \times \\ [ 2 \cdot 42 \times {10}^{- 3} + 3.6 ( {T}_{c} + {T}_{a} ) ( {T}_{c} - {T}_{a} ) \times {10}^{- 5} ] \times \end{matrix} \\ {[ \frac{{V}_{σω} {D}_{0} {ρ}_{f}}{1.32 \times {10}^{- 5} + 4.75 ( {T}_{c} + {T}_{a} ) \times {10}^{- 2}} ]}^{0.6} - α {D}_{o} {Q}_{3} sin {θ}_{s} \} / R ( {T}_{c} )\end{matrix}} ;$$
and
in the formula, Ta is an environmental forecast temperature, Tc is a lead temperature, V_{dw} is an error of a predicted wind speed and actual data, R(Tc) is a constant value, and other parameters are meteorological environment data along the line.

6. The disaster prevention, early warning and production decision support method for a power distribution network according to claim 2, wherein the calculating an average failure frequency and average failure time under a considered environmental factor is specifically as follows:
$${f}_{to} = {f}_{ad} {P}_{ad} + {f}_{no} ( 1 - {P}_{ad} ) ;$$
and
$${r}_{t o} = {r}_{a d} {P}_{a d} + {r}_{n o} ( 1 - {P}_{ad} ) ;$$
in the formula: f_{ad} and fₙₒ are respectively failure frequencies under hard and normal climatic conditions, fₜₒ is an average failure frequency, r_{ad} and rₙₒ are respectively average repair time under two climatic conditions, rₜₒ is average repair time during the whole period, and Pad and (1-P_{ad}) are probabilities of severe and normal climatic conditions.

7. The disaster prevention, early warning and production decision support method for a power distribution network according to claim 2, wherein the steps S4-S6 are specifically as follows:
stopping the device, starting the stand-by power supply path (or device) that is startable after the device is stopped and designed in an emergency management plan so as to update the topological structure of the power grid, analyzing the updated topological structure of the power grid, if an isolated land power grid operates away from a main grid, calculating the difference between power generation and the load for the isolated land power grid so as to obtain the power outage load, if the power grid remains intact, calculating the optimization problem of the minimum loss cutting load, solving the minimum loss cutting load required to be cut to maintain the power supply of a system key load under the condition of meeting the operation requirement of the power grid and the capacity constraint of the device, updating a non-power-outage probability of the calculated load required to be cut until traversing all affected device set, then calculating a power outage probability of each load, and finally calculating a power outage risk of an urban power distribution network in the case of the emergency;
calculating a risk R by using a product of an occurrence probability pᵢ of a disaster i and a hazard severity Cᵢ, wherein the disaster severity is expressed by a power outage load or is expressed by a value representing the importance of the load:
$$R = {\sum }_{i = 1}^{n} {p}_{i} {C}_{i} = {\sum }_{i = 1}^{n} {p}_{i} {c}_{i} {P}_{i}$$
a value coefficient cᵢ is generally determined artificially according to the demand of ensuring power supply in emergency management, for example, the load value of municipal government, hospital and transportation systems is large, and a larger value coefficient is set for related venues and traffic facilities during major public events such as the Olympic Games; and
analyzing the updated topological structure of the power grid, if an isolated land power grid operates away from a main grid, “calculating a difference between power generation and load for the isolated land power grid” so as to obtain a power outage load, and if the power grid remains intact, solving a load required to be cut to maintain the power supply of a system key load under the condition of meeting the operation requirement of the power grid and the capacity constraint of the device by using the optimization problem of the available minimum loss cutting load,
wherein a target function of the minimum loss cutting load problem is:
$$min G ( P ) = {\sum }_{i = 1}^{n} {c}_{i} ( {P}_{i} - {P}_{i}^{⋆} )$$
the constraint condition is:
$$\{ \begin{matrix}f ( V , θ , {P}^{⋆} , {Q}^{⋆} ) = 0 \\ \begin{matrix}{V}_{k}^{min} \leq {V}_{k} \leq {V}_{k}^{max} & k ϵ Ω\end{matrix} \\ \begin{matrix}- {F}_{l}^{max} \leq {F}_{l} \leq {F}_{l}^{max} & l ϵ Ψ\end{matrix}\end{matrix}$$
in the formula, P, is an initial active power of a load i, Pᵢ* is an active power of the load i after an emergent cutting load measure is taken, fis a network flow equation, V and θ are voltage and phase angle vectors of all nodes, P* and Q* are respectively active and reactive power vectors of all loads after the cutting load measure, It is a voltage amplitude of the node, 2 is a node set, Fₗ is a transmission power of a branch l, and Ψ is a branch set.

8. A disaster prevention, early warning and production decision support system for a power distribution network, applying the method according to claim 1 and comprising a multivariate data access module, an external public data module, a data fusion module and a display module, wherein the multivariate data access module is configured to access meteorological data, typhoon data, and lightning and mountain fire data; the external public data module is configured to store public early warning data; the data fusion module is configured to process various acquired data and applying model analysis to obtain a result; and the display module is configured to interact with a client, and display various original data acquired by the multivariate data access module, result data produced in the data fusion module and data stored in the external public data module to the client.

9. The disaster prevention, early warning and production decision support system for a power distribution network according to claim 8, wherein the meteorological data comprises real-time data, forecast data and historical data of a humidity, a precipitation, a temperature, a wind direction, a wind speed and an air pressure; the typhoon data comprises typhoon basic information, a typhoon grade, a forecast path, a real-time path and a forecast grade; the lightning and mountain fire data comprises a thunderfall point and a fire point; and the public early warning data comprises an early warning information title, a type, a grade, early warning text information, an early warning state, release time and end time.

10. The disaster prevention, early warning and production decision support system for a power distribution network according to claim 8, further comprising a service domain data module, wherein the service domain data module comprises a production domain module, a dispatching automation module, a marketing domain module, a power distribution automation module, a customer service module, a measurement automation module and a GIS module; a device ledger, a fault, a defect, a plan and power outage data are stored in the production domain module; an on-off action, a fault type and fault time are stored in the dispatching automation module; a customer ledger, a distribution transform ledger and power outage data are stored in the marketing domain module; an on-off action, a fault type and fault time are stored in the power distribution automation module; a geographic position, a distribution network topology and a risk hidden danger point are stored in the customer service module; a customer ledger, a distribution transform ledger and power outage data are stored in the measurement automation module; and the GIS module is provided with a GIS topology, a multi-functional layer, waterlogging and water leaching label and a distribution network line pole and tower dotting service.
